(19) United States
(12) Patent Application Publication
(10) Pub. No.: US 2008/0158246 A1
(43) Pub. Date: Jul. 3, 2008

(54) DIGITAL COLOR MANAGEMENT METHOD AND SYSTEM

(75) Inventors: Takatoshi Ishii, Sunnyvale, CA (US); Yunshu Zhang, Hefei (CN)

Correspondence Address: STRATEGIC PATENT GROUP, P.C., P.O. BOX 1329, MOUNTAIN VIEW, CA, 94042, US

(73) Assignee: TVIA, INC., Santa Clara, CA (US)

(21) Appl. No.: 11/619,537

(22) Filed: Jan. 3, 2007

(51) Int. Cl. G09G 5/02

(52) U.S. Cl. 345/604

(57) ABSTRACT

A method and system are provided for managing digital color for a display device having a display screen. Aspects the exemplary embodiments include receiving input display data comprising digital pixel data, wherein the data for each pixel represents 2D differential color space having X, Y coordinate values; remapping at least a portion of the coordinate values of the input display data locally in coordinates of the differential color space by reading from a memory of the display device color correction data that is configured to correct color errors of the display screen, wherein the color correction data is also represented in the differential color space, but the color correction data is only stored for a subset of X, Y coordinate values comprising the differential color space; interpolating the correction data read from the memory to generate remapped display data; and outputting the remapped display data for subsequent display.

### BACKGROUND OF THE INVENTION

Flat panel displays are becoming the display of choice for laptop, desktop, and handheld computers alike. There use in televisions is also growing. Flat-panel type displays can take a variety of forms, the most common of which is the liquid crystal type display. Other types include light emitting diode (LED) displays and plasma displays. Liquid crystal displays (LCD) include an active matrix type, which are also called TFT (Thin Film Transistor) type. TFT's are available in color versions and typically can have 256 shades of red, green, and blue (RGB). Such flat panel displays are driven by a controller which is typically a portion of an integrated circuit chip and is also referred to as a display controller or an LCD controller.

The display of color on LCD displays has inherent issues of color accuracy based on the principle of the liquid crystal display itself. Color accuracy has improved in recent years mostly due to the improvement of liquid-crystal panel technology, which has improved fundamentally better than other types of technology. However, if one compares a TFT LCD panel from one manufacturer with the TFT LCD panels from other manufacturers, or with TFT LCD panels from other production lots from the same manufacturer, it will be seen that the display color of the panels are not the same. Color variations between LCD panels occur even if the same display signal is input to the LCD's. This is known as LCD color error. Due to LCD color errors, the LCD has limited capacity to render gradations of primary colors smoothly, uniformly, and consistently. In addition, uniform backlighting across an LCD's entire display surface is difficult to achieve. Therefore, it is not uncommon for an LCD to have bright or dim patches or subtler variations in color intensity, which give the appearance of shading across the screen, or variable color intensity on the display.

As the production of large-sized TFT LCD panels becomes increasingly more common and popular, the display color differences between TFT LCD panels themselves and between TFT LCD panels and cathode ray tubes (CRTs) will become more apparent in the consumer market, and will therefore become an increasingly larger problem. In CRT applications, by contrast there is almost no difference in display color between CRTs lot-to-lot or from maker-to-maker.

An analogy can be drawn from the printer industry in which the print color differences between printers were exposed to the consumer public early on. And since print color was regarded as questionable from the start, color management technology for printing was developed early. However, the color management of printers is not easily adapted to flat-panel video applications. Printing color management in printers is based on red, green, blue (RGB) color space. RGB is three dimensions represented by three coordinates in RGB space (x, y, z). RGB color management utilizes very large RGB 3-dimensional conversion table for storing color correction data that is processed by a controller. The three-dimensional conversion table is used to remap input data that would produce an incorrect color to a correct value that produces the correct color. Each RGB value ranges from 0-255. Therefore, a three-dimensional RGB conversion table of 256×256×256×3=50 MB of memory is needed. Because the printing speed of a printer is slower than video data speed, processing the color management and the conversion tables by software in a processor does not pose a performance problem in printers. Not only is the size of the conversion table prohibitive for use in flat-panels, but remapping in 3-dimensional color space is unworkable for performing real-time color correction during the display of video on an flat-panels due to the high data rates involved.

Accordingly, there is a need for an improved color management method and system that compensates for color errors produced by display devices, such as flat-panel LCD displays.

### BRIEF SUMMARY OF THE INVENTION

The present invention provides a method and system for managing digital color for a display device having a display screen. Aspects the exemplary embodiments include receiving input display data comprising digital pixel data, wherein the data for each pixel represents 2D differential color space having X, Y coordinate values; remapping at least a portion of the coordinate values of the input display data locally in coordinates of the differential color space by reading from a memory of the display device color correction data that is configured to correct color errors of the display screen, wherein the color correction data is also represented in the differential color space, but the color correction data is only stored for a subset of X, Y coordinate values comprising the differential color space; interpolating the correction data read from the memory to generate remapped display data; and outputting the remapped display data for subsequent display.

According to the method and system disclosed herein, the exemplary embodiment improves overall image quality of the display device by remapping display data to compensate for the color error of the display screen. The size of the table used to store the color correction data is effectively reduced by 1) executing color remapping in 2-dimensional color differential space, as opposed to remapping in 3-dimensional color space, and 2) the color correction data is compressed by storing the data only for subset of coordinates in the color differential space and then is decompressed through interpolation. Accordingly, a digital color management method and system is provided for display devices that can be performed in real-time for video applications.

### BRIEF DESCRIPTION OF SEVERAL VIEWS OF THE DRAWINGS

FIG. 1 is a block diagram illustrating a display device for use in accordance with an exemplary embodiment.

FIG. 2A is a flow diagram illustrating a method for managing digital color of the display device.

FIG. 2B is a diagram graphically illustrating 3D RGB color space.

FIG. 2C is a diagram graphically illustrating 2D YCC differential color space.

FIG. 3 is a diagram illustrating the differential color space FIG. 2C divided into a color space grid according to one exemplary embodiment.

FIG. 4 is a block diagram illustrating components of the pixel process pipeline that provides a digital color management system for correcting color error of the display screen.

FIG. 5 is a diagram illustrating bit-widths of the data input to and output from the local color remap block.

FIG. 6 is a block diagram illustrating components of the local color remap block according to an exemplary embodiment.

FIG. 7 is a diagram illustrating an exemplary data structure of differential color data output by the color space converter.

FIG. 8 is a diagram illustrating components of the remapper unit in accordance with one embodiment.

FIG. 9 is a diagram graphically illustrating organization of the remapper tables and the process performed by the 2D remapper blocks for interpolating the color correction data stored therein.

FIG. 10 is a diagram illustrating interpolation operation of the 2D remap tables in further detail. Input coordinate is shown falling within one block of grid points/addresses in the remap table.

FIG. 11 is a block diagram illustrating how the E/O bit is used to control data access from table blocks.

FIG. 12A is a diagram showing the remap tables are implemented as 17×17 memories.

FIG. 12B is a diagram showing each remap table divided into four blocks.

FIG. 12C is a diagram showing 8×8 four memory blocks having an extra 1 bit column or row.

FIG. 13 a diagram showing a 2D interpolation circuit for implementing the 2D table remappers shown in FIG. 8.

FIG. 14 is a diagram illustrating one embodiment an interpolator module for implementing the interpolators.

FIG. 15 is a diagram illustrating bit arrangement of the interpolator module internal data bus bit alignment of variables used for generating the remapped differential color data according to an exemplary embodiment.

FIGS. 16A, 16B, and 16C are diagrams illustrating several embodiments for a multi-layered color space grid improved interpolation.

FIG. 17 is a block diagram of components of a remapper unit for implementing the two-layer color space grid of FIG. 16A.

FIG. 18 is a block diagram of components of a remapper unit for implementing the three-layer color space grid of FIG. 16B.

FIG. 19 is a block diagram of components of a remapper unit for implementing the adjustable multi-layer color space grid of FIG. 16C.

FIG. 20 is a diagram illustrating input data to base, middle, and small grid table address shift selection performed by the remapper of FIG. 18 in accordance with one embodiment of the present invention.

### DETAILED DESCRIPTION OF THE INVENTION

The present invention relates to color management for display devices. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The embodiments disclosed herein are mainly described in terms of particular device and system provided in particular implementations. However, one of ordinary skill in the art will readily recognize that this method and system will operate effectively in other implementations. For example, the circuits and devices usable with the present invention can take a number of different forms. The present invention will also be described in the context of particular methods having certain steps. However, the method and system operate effectively for other methods having different and/or additional steps not inconsistent with the present invention.

RGB is a color space in which the colors red, green and blue can be considered as X, Y and Z axes of a 3-dimensional space, where every possible color has a unique position or coordinate. Other color spaces include an intensity or luminance signal (1-dimensional) and two color differential signals (2-dimensional color differential space). Such color spaces are referred to herein as color differential spaces. Examples types of differential color spaces include YCC, YUV, YIQ, and HSV, for instance.

YC_{b}Cᵣ is a family of color spaces used in video systems, which is often abbreviated to YCC. YC_{b}Cᵣ defines a color space in terms of one luminance (the brightness) and two chrominance (color) components. Y is the luma component and C_{b} and Cᵣ are the blue and red chroma components, respectively. In YC_{b}Cᵣ, the C_{b} and Cᵣ components can be thought of as X and Y coordinates within 2-dimensional differential color space. The C_{b}, (X coordinate) values range from 0 to 255, and the Cᵣ (Y coordinate) values range from 0 to 255. The Y component can be thought of as the Z coordinate.

In analog video systems, the YP_{b}Pᵣ color space is used, which is numerically equivalent YC_{b}Cᵣ. YCC is often confused with the YUV color space, which also defines a color space in terms of one luminance and two chrominance components. Y stands for the luminance component and U and V are the chrominance components. In YUV, the U and V components comprise X and Y coordinates within the 2-dimensional differential color space. YIQ is a similar color space in which the Y component represents the luma information, while I and Q represent the chrominance information. I and Q can be thought of as a second pair of axes on the same graph, rotated 33°; therefore IQ and UV represent different coordinate systems on the same plane. Another way of making the same colors is to use their hue (X axis), their saturation (Y axis) and their brightness (Z axis). This is called the HSV color space, where hue and saturation comprise X and Y coordinates within the 2-dimensional differential color space.

As explained above, the display of color on LCD displays has inherent issues of color accuracy. LCD color error produces color variations between LCD panels even if the same display signal is input. But performing color management in RGB space using 3-dimensional conversion tables that store color correction data, as done in printers, is impractical for performing real-time color correction on a flat-panel display during the display of video.

According to the exemplary embodiment, a digital color management and system is provided for correcting color errors in display devices, such as flat-panels. The color management system may include transforming RGB color space signals into differential color space, if not already in differential color space, and remapping the coordinates of the input display data locally in the 2-dimensional coordinates of the differential color space by specifying displacement of the color coordinates to a new output color coordinates, thereby compensating for the error of the display color difference caused by the display screen.

More specifically, during a configuration phase, color errors are first measured across a flat-panel display screen, and color correction data configured to correct the color errors is created. The color correction data may be considered as a displacement of input display data coordinates to new output color coordinates that compensate for the color error. The color correction data is then stored in a small memory in the flat-panel, and is preferably compressed by storing the color correction data for only a subset of coordinates comprising the differential color space. During operation of the flat-panel, the color management process receives the input display data represented in differential color space. If the input display data is originally in 3-dimensional RGB color space, then the RGB input display data is first transformed into 2-dimensional differential color space. As the flat-panel is scanned to display an image from the display data, the color correction data in the memory is decompressed by reading only the color correction data surrounding a current pixel value of the display data from the memory, and then real-time interpolation is performed on the color correction data to generate remapped display data for the current pixel. The remapped display data is then displayed on the display screen, thereby providing improved image quality.

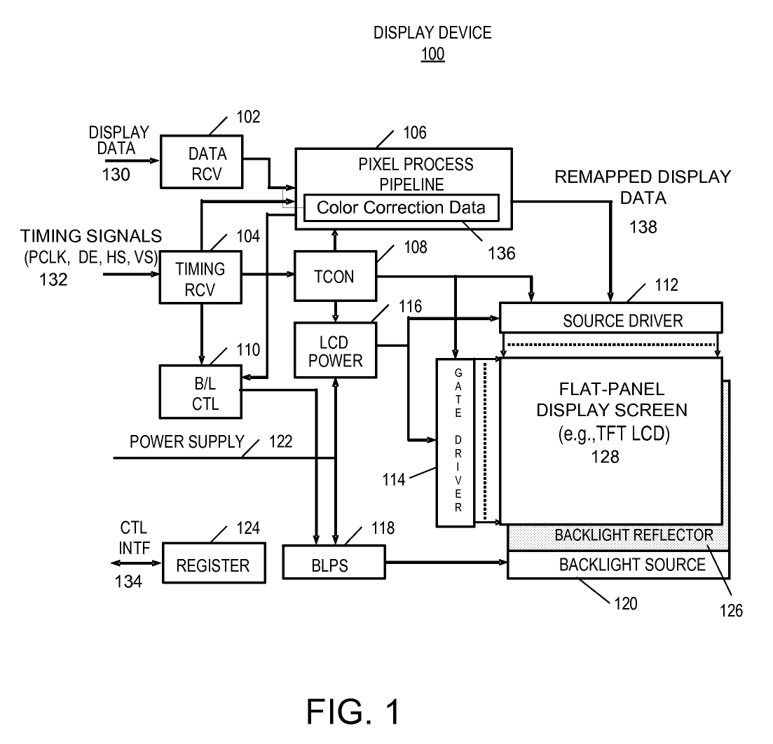

FIG. 1 is a block diagram illustrating a display device for use in accordance with an exemplary embodiment. The display device 100 includes components necessary for receiving, processing, and displaying display data 130 on a color flat-panel display screen 128 (hereinafter referred to as display screen 128). Although the display screen 128 is shown as a thin-film transistor (TFT) liquid crystal display (LCD), the display device 100 may include other types of flat-panel displays, such as a plasma display. In addition, the exemplary embodiment is not intended to be limited to any one display technology, and should be applicable to all types of displays where pixels are discreetly commanded towards one of a bright or dark level.

Conventional components of the display device 100 for producing a picture on the display screen 128 include a data receive block 102, a timing receive block 104, a timing control (TCON) block 108, a backlight control (B/L CTL) block 110, a source driver 112, a gate driver 114, a LCD power control 116, a backlight power supply inverter (BLPS) 118, a backlight source 120, a backlight reflector 126, and a register block 124. In accordance with the exemplary embodiment, the display device 100 is further provided with a pixel process pipeline 106 that enhances the incoming display data 130 to improve display picture quality, as explained further below.

In one embodiment, the display screen 128 is capable of displaying display data at 8-bit resolution, meaning that 256 shades of grayscaling can be displayed. As those with ordinary skill in the art will readily understand, the term “grayscale” may apply to color displays where the brightness or perceived luminance of a colored region is to vary across a pre-determined intensity range.

Display data 130 comprising a sequence of video frames is input to the data receive block 102. Each frame is an image of RGB (Red, Green, Blue) digital pixel data. In one embodiment, each pixel in the image includes 8 or 10-bit data for each RGB component. The data receive block 102 receives the input display data 130 and outputs the display data 130 to the pixel process pipeline 106. The timing receive block 104 receives timing signals 132 from a display controller (not shown) and outputs the timing signals to the timing control block (TCON) 108, the backlight control block 110, and the pixel process pipeline 106. The timing signals 132 may include a pixel clock (PCLK) signal, a display enable (DE) bit, a horizontal sync (HS) signal, and a vertical sync (VS) signal. The timing control block (TCON) 108 generates further internal timing control signals for the pixel process pipeline 106, the source driver 112, the gate driver 114, and the LCD power control 116.

The LCD power control 116 may include a DC-to-DC converter and generates relatively high voltage for the source driver 112 and gate driver 114. The backlight control block 110 generates backlight control signals, which are output to the backlight power supply inverter 118. The backlight power supply inverter 118 generates high voltage for backlight lighting, which is supplied to the backlight source 120. The backlight reflector 126, in turn, distributes the light from the backlight source 120 as evenly as possible. The value of the high voltage depends on the type backlight source 120, e.g., CCFL (Cold Cathode Fluorescent Lamps) or LED (Light Emitted Diode). Necessary electric power is supplied by a power supply line 122 from a host computer system (not shown). The LCD power control 116 and the backlight power supply inverter 118 convert the voltage from the power supply line 122 to meet the requirements of the source driver 112, gate driver 114, and the backlight source 120. All necessary parameters for the above operations are given from a register value in the register block 124, which are written and read through a control interface (CTL INTF) signal by system software or one of peripherals from a computer system (not shown).

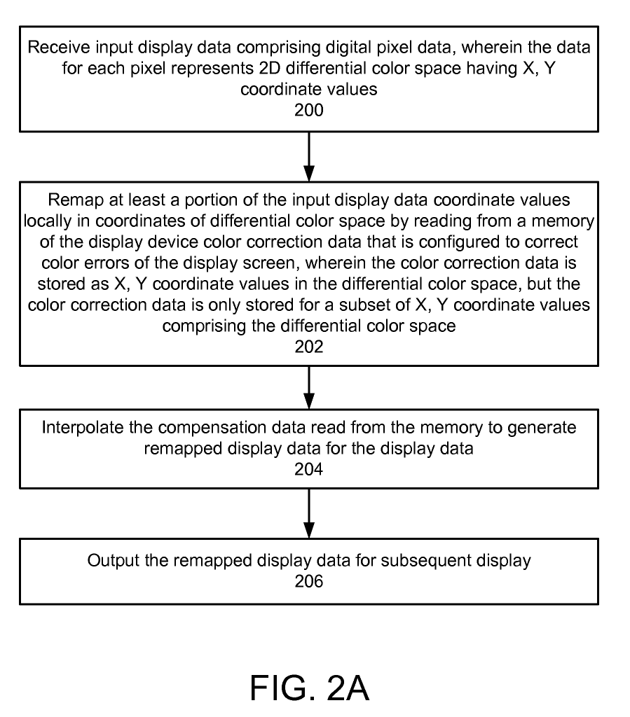

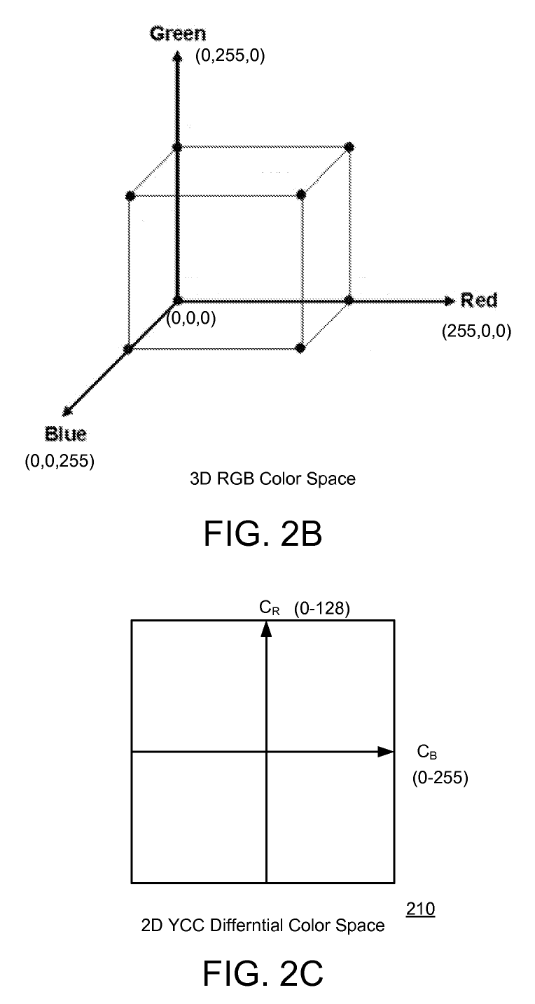

In accordance with the exemplary embodiment, the pixel process pipeline 106 shown in FIG. 1 provides a digital color management system for effectively correcting color error of the display screen 128, as described with reference to FIG. 2A.

FIG. 2A is a flow diagram illustrating a method for managing digital color of the display device. Referring to both FIGS. 1 and 2A, the process begins in step 200 wherein the pixel process pipeline 106 receives display data 130 comprising digital pixel data, wherein the data for each pixel represents 2-dimensional differential color space having X, Y coordinate values. In one embodiment, the display data coordinate values are received in RGB color space, and the pixel process pipeline 106 transforms the RGB coordinate values of the display data 130 into differential color space coordinates. In another embodiment, the display data 130 may be received in differential color space.

In step 202, the pixel process pipeline 106 remaps at least a portion of the coordinate values of the input display data locally in coordinates of differential color space by reading from a memory of the display device 100 color correction data 136 that is configured to correct color errors of the display screen, wherein the color correction data is also stored as X, Y coordinate values in the differential color space, but the color correction data is only stored for a subset (i.e., less than the total number) of X, Y coordinate values comprising the differential color space. In one embodiment, the color correction data differential color coordinate values specify a displacement of input color space coordinates to new output color space coordinates, thereby remapping the input colors to colors that are most near to the correct colors.

FIG. 2B is a diagram graphically illustrating 3D RGB color space. When the input display data is represented as 8-bit RGB data per pixel (total 24-bit or 16 million color data), the color space coordinates for R, G, and B each range in value from 0 to 255, where in this example, R is shown along the X axis, B along the Y axis, and B along the z axis. Performing remapping in 3D RGB space to correct color for real-time video is impractical due to the number or RGB coordinates. Therefore, according to the exemplary embodiment, the color management system performs remapping in 2D differential space, which is illustrated in FIG. 2C.

FIG. 2C is a diagram graphically illustrating 2D YCC differential color space 210. Here, C_{b} and Cᵣ are X and Y coordinates within the 2D differential color space 210. The C_{b} X-coordinate values range from 0 to 255, and the Cᵣ coordinate values range from 0 to 256. The Y-component can be thought of as a 1D Z coordinate representing intensity.

According to one embodiment, the color correction data 136 is created and stored during a configuration stage, which could occur for example, during manufacturing/testing of the display device 100 and/or the display screen 128. During the configuration stage, color error of the display screen 128 is measured using well-known methods (e.g., color meter), and color correction data for correcting the color error is determined. The color correction data could be stored for each differential color space coordinate, but this would normally require a relatively large memory table size of 256²=64k.

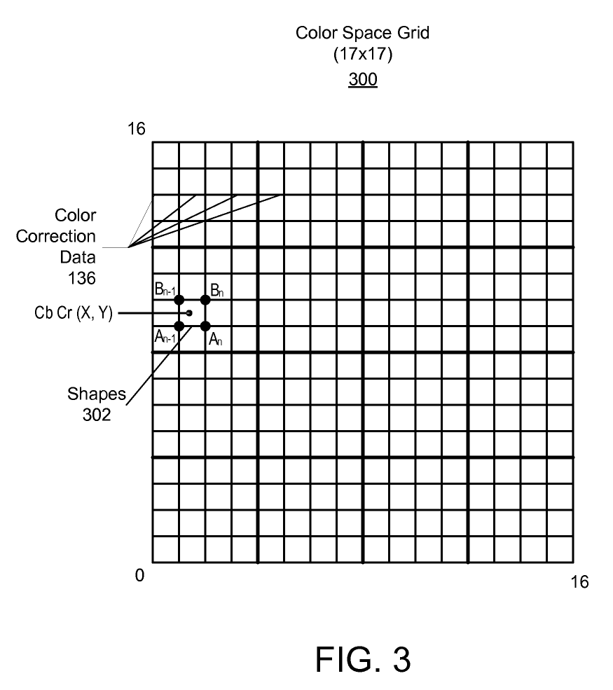

According to the exemplary embodiment, the color correction data 136 is compressed to reduce storage space requirements by storing the color correction data 136 only for a subset of differential color space coordinates in one or more memories (described below) of the display device 100. According to one aspect of the exemplary embodiment, the subset of differential color space coordinates is defined by dividing the differential color space 210 into a color space grid of rows and columns, wherein points at row and column intersections of the color space grid are used to define shapes that encompass multiple differential color space coordinates, as shown in FIG. 3.

FIG. 3 is a diagram illustrating the differential color space 210 of FIG. 2C divided into a color space grid 300 according to one exemplary embodiment. The differential color space 210 is divided into a color space grid 300 of N horizontal rows and N vertical columns, and intersections of these lines make grid points. In one embodiment, the differential color space 210 is divided into a 17×17 color space grid 300, where the X and Y coordinate values of the grid 300 both range from 0-16, thereby storing 289 color correction values.

Adjacent points at row and column intersections of the color space grid 300 are used to define a matrix of shapes 302 that encompass multiple coordinates in the differential color space 210. In an exemplary embodiment, the shapes 302 defined by the points at the row and column intersections are blocks, which are bounded by four grid points. For example, a set of C_{b} and Cᵣ at coordinates (X, Y) of the differential color space 210 fall within a block defined by the four points labeled An, An−1, Bn, and Bn−1. In alternative embodiments, the points may be selected to define shapes 302 other than blocks, such as rectangles, circles, and polygons for example. In each example, each type of shape 302 should encompass sets of differential color space coordinates.

According to the exemplary embodiment, the color correction data 136 is compressed to reduce storage space requirements by storing in a memory of the display device 100 the color correction data 136 only for the grid points of the color space grid 300 that define shapes 302. In one embodiment, values for the color correction data 136 may be stored specifically for each grid point (e.g., Bn, Bn−1, Bn−2, . . . , An−n; An, An−1, An−2, . . . , An−n).

Referring again to FIG. 2A, as the display screen 128 is scanned to display an image, in step 204, the pixel process pipeline 106 interpolates the color correction data 136 to generate the remapped display data 138 for the display data 130, thereby decompressing the color correction data. More specifically, referring to FIGS. 1 and 3, in response to receiving differential color space coordinate values for a current pixel from the display data 130, e.g., C_{b} and Cᵣ, the pixel process pipeline 106 reads the color correction data 136 corresponding to the shape 302 encompassing the C_{b} and Cᵣ, coordinates within the grid 300, e.g., color correction data for points An, An−1, Bn, and Bn−1, and interpolates this color correction data 136 to generate the remapped display data 138 for the current pixel. Thus, through interpolation of the compressed color correction data 136, remapped display data 138 can be generated for all of the differential color space coordinate values, even for coordinate values that have no stored color correction data 136, thereby reducing memory requirements.

In step 206, the pixel process pipeline 106 outputs the remapped display data 138 for display on the display screen 128.

According to the method and system of the exemplary embodiment, a color management system for display devices is provided that remaps display data 138 to compensate for the color error of the display screen, effectively improving overall image quality of the display device. Because the color remapping is executed in 2-dimensional color differential space and compressed using the color space grid 300, it can be performed in real-time by display device 128 for video applications. Since the bi-linear interpolation of the remapping table is also carried out on a 2-dimensional table, the required table size is also much less than what would be required for 3-dimensional table.

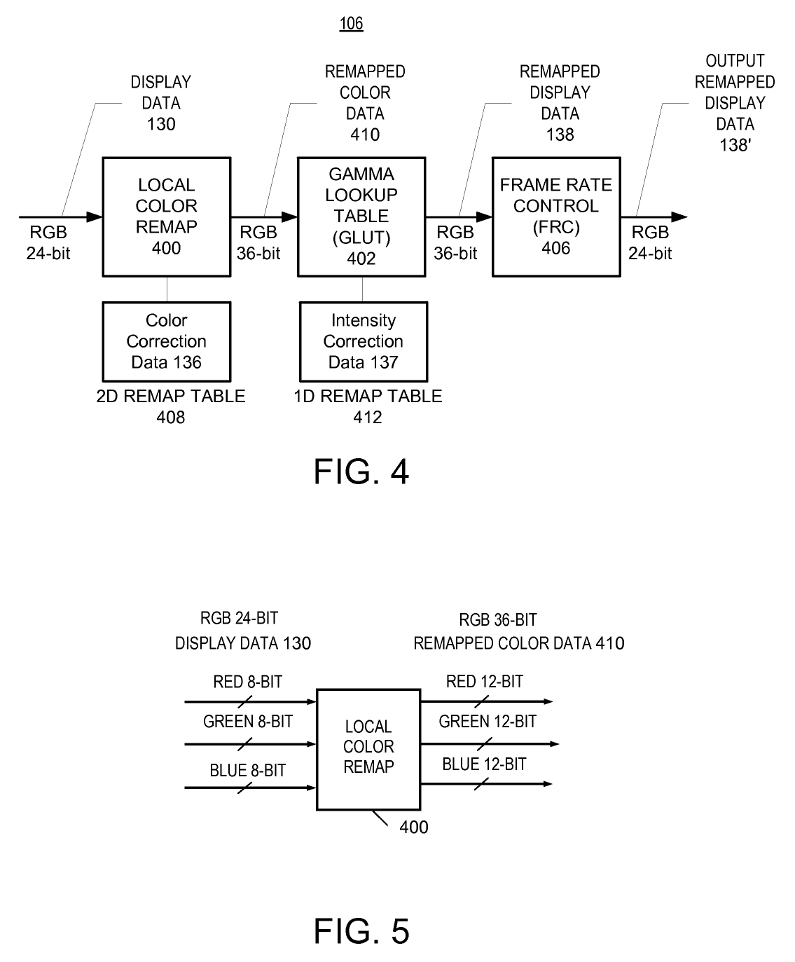

FIG. 4 is a block diagram illustrating components of the pixel process pipeline 106 that provides a digital color management system for correcting color error of the display screen. In one exemplary embodiment, the pixel process pipeline 106 may include a local color remap block 400, a gamma lookup table (GLUT) block 402 coupled to the local color remap block 400, a frame rate controller (FRC) 406 coupled to the GLUT 402, a 2D remap table 408, and a 1D remap table 412.

The local color remap block 400 corrects would be color errors of the display screen 138 by remapping the RGB display data 130 within 2D differential color space using the 2D remap table 408 containing the color correction data 136, and outputs remapped color data 410. More specifically, the local color remap block 400 is the component that performs interpolation on the color correction data 136 stored in the 2D remap table 408 to generate remapped color data 410 that at least in part compensates for the color error of the display screen 128.

FIG. 5 is a diagram illustrating bit-widths of the data input to and output from the local color remap block 400. In the embodiment shown, the display data 130 may be input as 8-bit RGB data (total 24-bit or 16 million color data), but after remapping the color correction data 136 locally and independently through interpolation, the local color remap block 400 is capable of outputting the remapped color data 410 as 12-bit RGB data (total 36-bit or 64 billion color data).

Referring again to FIG. 4, the GLUT block 402 performs gamma correction on the remapped RGB display data 410 using a 1D remap table 412 containing intensity correction data 137 to control the overall brightness of a displayed image and outputs remapped display data 138 as RGB 12-bit data (36-bits total). The GLUT block 402 may be optionally configured to perform white balance control also.

The FRC 406 optionally performs dynamic dither on the remapped display data 138 and reduces the bit width of the RGB output remapped display data 138′ from 12 to 8-bits (24-bits total) to match the data width of the display screen 128. Although gamma correction of the remapped RGB the display data 410 provided by the GLUT block 402 is shown as a part of the pixel process pipeline 106, gamma correction functions and/or functions of the FRC 606 are optional and may be performed outside the pixel process pipeline 106.

As shown, the data width of display data 130 input to, and output from, inside modules of the pixel process pipeline 106 may be changed by data processing. For example, the local color remap block 400 may increase the data width of the incoming display data 130 for more precise correction. As described above, the display data 130 may be input as 8 or 10-bit RGB each, but the local color remap block 400 outputs the remapped color data 410 as 12-bit RGB each. The GLUT block 402 also outputs the remapped display data 138 as 12-bit RGB. Thereafter, the FRC 406 is used to reduce the data width of the remapped display data 138 to match the data width of the source driver 112 prior to display. In one embodiment, the FRC 406 uses a static dither or dynamic dither algorithm and converts the 12-bit remapped display data 138 to 8-bit output remapped display data 138′ for display.

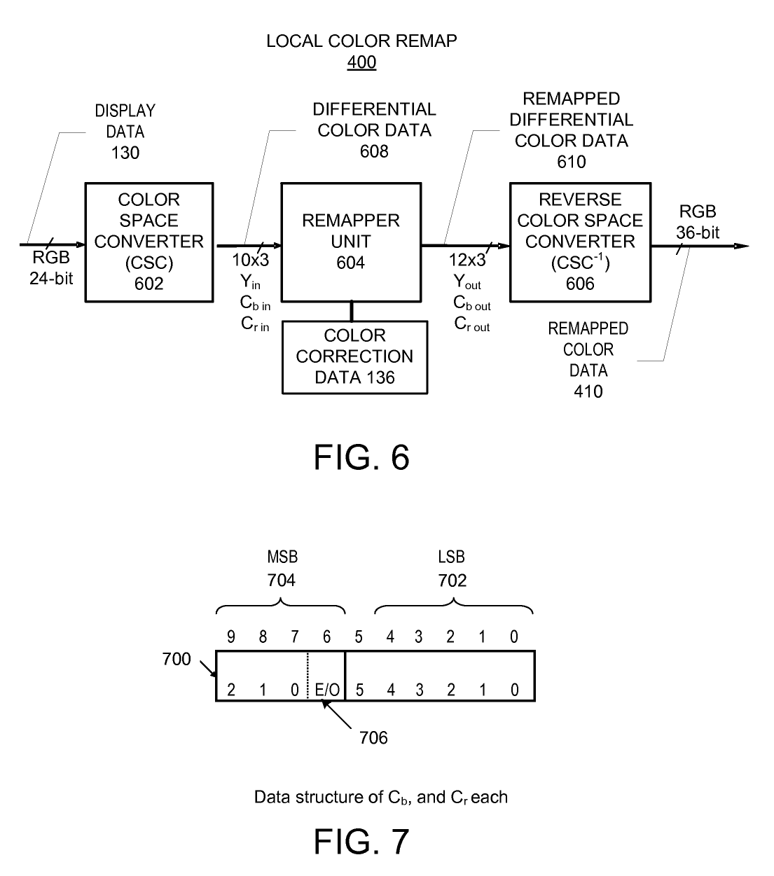

FIG. 6 is a block diagram illustrating components of the local color remap block 400 according to an exemplary embodiment. As described above, local color remap block 400 transforms RGB color space signals into differential color (2-dimensional) signals and one intensity (1-dimension) signal. The differential color signals are remapped/rearranged within the 2-dimensional coordinates of the differential color space 210. The differential color signals after this remapping/rearrangement are transferred back into RGB color space for display.

Accordingly, the local color remap block 400 may include means for converting input display data 130 from RGB color space to differential color space signals. For example, the local color remap block 400 may include a color space converter 602 that converts the input display data 130 from a color space such as RGB to a differential color space, such as YC_{b}Cᵣ (Y=intensity and C_{b} and Cᵣ=2-dimensional color), and outputs the result as differential color data 608. The following are equations that may be used by the color space converter 602 to convert the RGB display data 130 into Y601, C_{b}, and Cᵣ (for one example):

Y601=0.257R+0.504G+0.098B+16

C_{b}=−0.148R−0.291G+0.439B+128

Cᵣ=0.439R−0.368G−0.071B+128

### In the embodiment where the display data 130 is received as 24-bit RGB data, the color space converter 602 outputs the differential color data 608 as 30-bit Y, C_{b}, and Cᵣ.

FIG. 7 is a diagram illustrating an exemplary data structure 700 of differential color data 608 output by the color space converter 602 per pixel. Each component, C_{b}, and Cᵣ, of the differential color data structure 700 is 10-bits in length. Bits 0 through 5 are designated as least significant bits (LSB) 702, bits 6 through 9 are designated as most significant bits (MSP) 704, and bit 6 is designated as an even/odd bit.

Referring again to FIG. 6, the local color remap block 400 may also include means for remapping the input display data, which is input to the local color remap block 400 as the differential color data 608. For example, the local color remap block 400 may include a remapper unit 604 that receives the differential color data 608, and as explained above, remaps coordinate values of the differential color data 608 locally in coordinates of the differential color space 210 by reading from the 2D remap table 408 the color correction data 136, and interpolating the color correction data 136 to generate remapped differential color data 610. In the example where the RGB display data 130 is converted to Y601, C_{b}, and Cᵣ, the remapper unit 604 remaps/rearranges the input differential color data 608 in the Y601, C_{b}, and Cᵣ color space coordinates.

The 2D remapper table 408 that implements the color space grid 300 and stores the color correction data 136 may comprise separate remapping tables for C_{b}, and Cᵣ, respectively. These tables store only discrete grid locations (e.g., every 16/8/4 address of 256 C_{b} and Cᵣ addresses). The remapper unit 604 then performs bi-linear interpolation (i.e., linear interpolation in 2-dimensional coordinates) between each discrete (every 16/8/4 address of 256 addresses) grid point to generate the remapped differential color data 610 based on the input coordinates of (C_{b} and Cᵣ) and corresponding values in the internal remapping tables. In the embodiment where the remapper unit 604 receives 30-bit Yᵢₙ, C_{b in}, and C_{r in} differential color data 608, the remapper unit 604 outputs 36-bit Yₒᵤₜ, C_{b out}, and C_{r out}.

The local color remap block 400 may further include means for converting the YCC data output by the remapper unit 604 back to RGB. For example, the local color remap block 400 may include a reverse color space converter 606 that converts the remapped differential color data 610 back into RGB remapped color data 410. In the embodiment where reverse color space converter receives 36-bit Yₒᵤₜ, C_{b out}, and C_{r out} remapped differential color data 610, the reverse color space converter outputs 36-bit RGB remapped color data 410.

The following are equations that may be used by the reverse color space converter 606 to convert Y601, C_{b}, and Cᵣ back into RGB (for one example):

R=1.164(Y601−16)+1.596(Cᵣ−128)

G=1.164(Y601−16)−0.813(Cᵣ−128)−0.391(C_{b}−128)

B=1.164(Y601−16)+2.018(C_{b}−128)

The following is another example set of equations for color space conversions. For transforming RGB to Y709, C_{b}, and Cᵣ, the color space converter 602 may use the following equations:

Y709=0.183R+0.614G+0.062B+16

C_{b}=−0.101R−0.338G+0.439B+128

Cᵣ=0.439R−0.399G−0.040B+128

The remapped Y709, C_{b}, and Cᵣ data may then be re-transformed into RGB space by the reverse color space converter 606 using following equations:

R=1.164(Y709−16)+1.793(Cᵣ−128)

G=1.164(Y709−16)−0.534(Cᵣ−128)−0.213(C_{b}−128)

B=1.164(Y709−16)+2.115(C_{b}−128)

In one embodiment, the color space converter 602, the remapper unit 604, and the reverse color space converter 606 are implemented as hardware components. However, the color space converter 602, the remapper unit 604, and the reverse color space converter 606 may be implemented as software components, or a combination of hardware and software. Although the color space converter 602, the remapper unit 604, and the reverse color space converter 606 are shown as separate components, the functionality of each may be combined into a lesser or greater number of components.

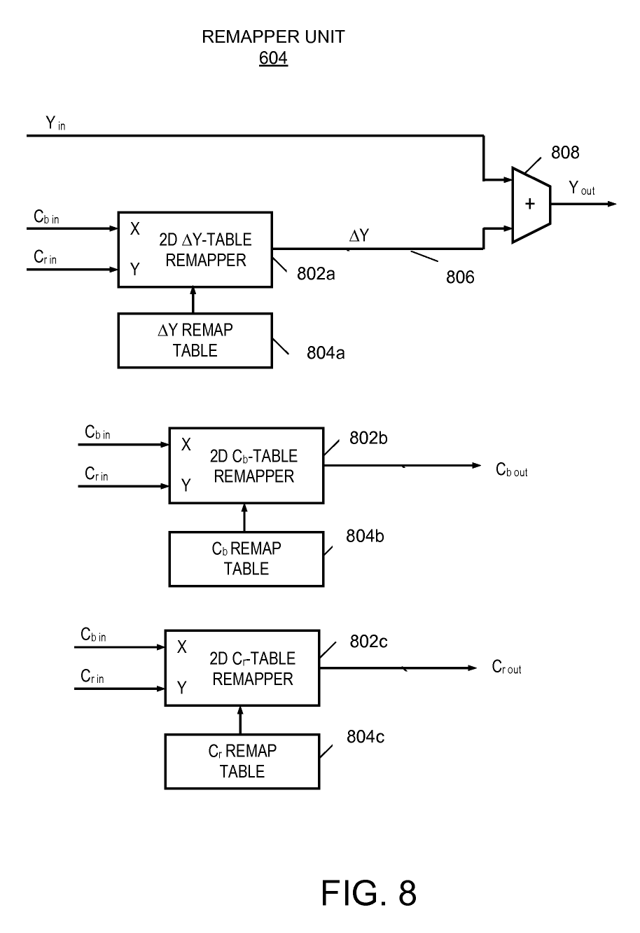

FIG. 8 is a diagram illustrating components of the remapper unit 604 in accordance with one embodiment. The remapper unit 604 includes means for receiving differential color data 608 (e.g., Yᵢₙ, C_{b in}, and C_{r in}), remapping the differential color data 608 in 2D differential color space 210 and, outputting the remapped differential color data 610 (e.g., Yₒᵤₜ, C_{b out}, and C_{r out}).

For example, the remapper unit 604 may include separate table remapper blocks 802a, 802b, and 802c (collectively referred to as table remapper blocks 802) and corresponding remap tables 804a, 804b, and 804c (collectively referred to as remap tables 804) for storing the color correction data 136 for Y, C_{b}, and, Cᵣ. Inputs to each of the table remapper blocks 802 are C_{b in}, and C_{r in}.

Color correction for Yᵢₙ may be performed by the 2D ΔY table remapper 802a and ΔY remap table 804a, producing Yₒᵤₜ. The ΔY remap table 804a may store color correction data 136 for changing intensity values, producing a ΔY value 806. Yᵢₙ and the ΔY value 806 are then input to an adder 808 and summed to produce Yₒᵤₜ.

Color correction for C_{b in} may be performed by 2D C_{b} table remapper 802b and C_{b} remap table 802c, producing C_{b out}. The C_{b} remap table 804b may store color correction data 136 for remapping X-coordinates of the differential color space. And color correction for C_{r in} may be performed by 2D Cᵣ table remapper 802c and Cᵣ remap table 804c, producing C_{r out}. The Cᵣ remap table 804c may store color correction data 136 for remapping Y-coordinates of the differential color space.

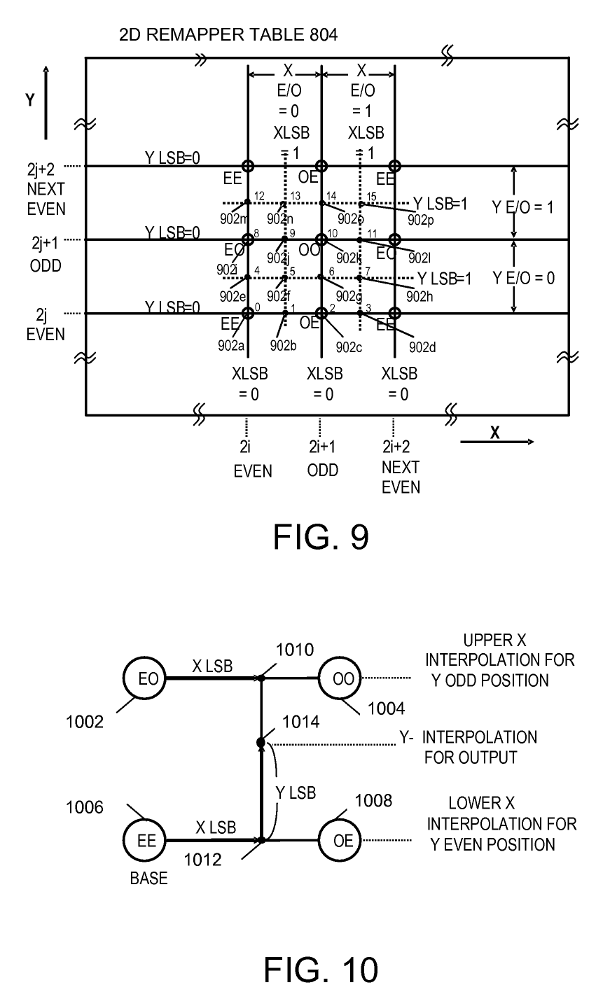

FIGS. 9 through 12A-C are diagrams graphically illustrating organization of the remapper tables 804 and the process performed by the 2D remapper blocks 802 for interpolating the color correction data stored therein. As described above, each of the 2D remap tables 804 is an implementation of the 17×17 color grid 300 shown in FIG. 3. The remap tables 804 are addressed using the MSB 704 portions of the 10-bit C_{b}, and Cᵣ, input coordinates of the differential color data 608, shown in FIG. 7. The MSB for C_{b} input coordinates is used for X/row addressing, and the MSB of Cᵣ is used to address Y/column addressing.

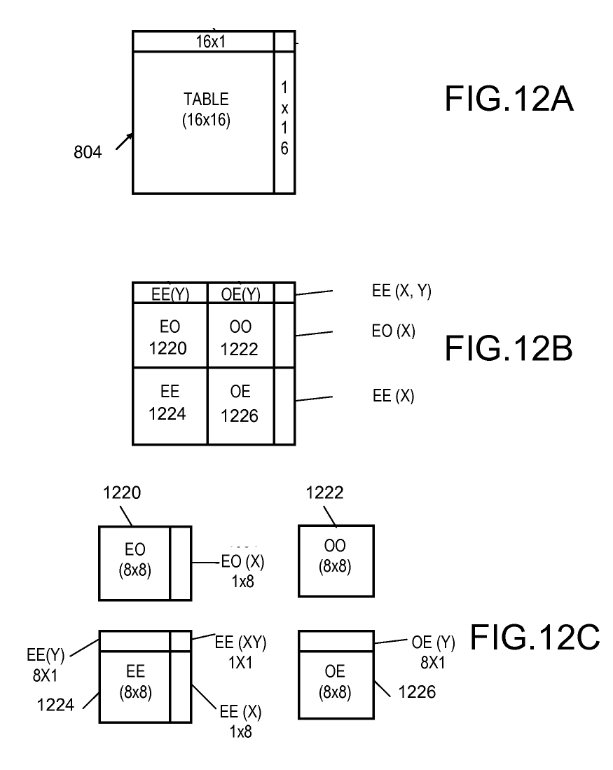

The middle part of the remap tables 804 (for example, 01 to 0F_{H} or E1 to EF_{H}) can be interpolated using 17×17 table data. But, it is necessary to add one last table row/column (100_{H}) to interpolate the last top/right area (F1 to FF_{H}). Accordingly, the remap tables 804 are implemented as 17×17 memories, as shown in FIG. 12A.

Referring again to FIG. 9, the remap tables 804 have even (E) and odd (O) row and column addresses. When input coordinates of the differential color data 608 fall between row and column addresses in the remap tables 804, the color correction data (not shown) stored at the four even and odd row and column addresses encompassing the input coordinates 902 need to be read and then interpolated.

FIG. 10 is a diagram illustrating interpolation operation of the 2D remap tables 804 in further detail. Input coordinate 1014 is shown falling within one block of grid points/addresses in the remap table 804. While the MSB 704 portions of the 10-bit C_{b}, and Cᵣ, input coordinates of the differential color data 608 are used to address the 17×17 remap tables 804, the LSB 702 portions are used for the interpolation. Interpolation is first performed in the X direction between two adjacent row grid points using the C_{b} LSB portions, followed by interpolation in the Y direction using the Cᵣ LSB portion. X-interpolation comprises a lower X interpolation for the lower X grid points 1006 and 1008 in the block, and an upper X interpolation for the upper X grid points 1004 and 1004, producing interpolated X values 1012 and 1010, respectively. Once the lower and upper X-interpolations are complete, then Y-interpolation is performed between the two interpolated X values 1012 and 1010, producing an interpolated Y value for input coordinate 1014.

As shown in FIG. 9, there are four possible cases of the input coordinate values 902 falling between even and odd row addresses, and even and odd column addresses of the remap tables 804. That is, the input coordinate value 902 can fall between even/odd memory blocks, or odd/even memory blocks in both the X and Y directions, shown as EO, OO, EE, and OE.

As shown in FIG. 12B, in accordance with one exemplary embodiment, each remap table 804 is divided into four blocks corresponding to four possible even/odd row and column address combinations; EO 1220, OO 1222, EE 1224, and OE 1226. As shown in FIG. 12C, since the remap tables 804 are 16+1×16+1, each of the four blocks EO 1220, OO 1222, EE 1224, and OE 1226 is 8×8, with the extra 1 bit column or row, as shown.

According to the exemplary embodiment, the E/O bit 706 of the 10-bit C_{b}, and Cᵣ, input coordinates (FIG. 7) is used to determine which block to fetch the color correction data from.

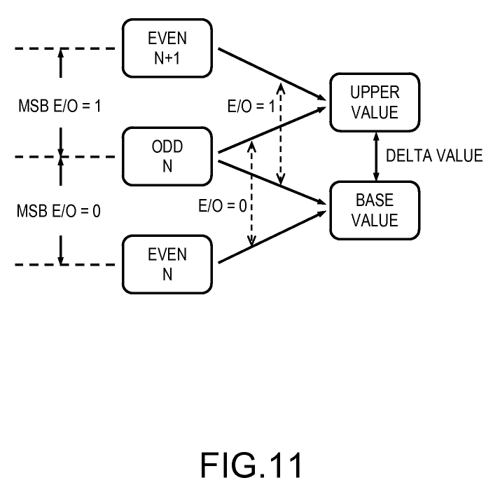

FIG. 11 is a block diagram illustrating how the E/O bit is used to control data access from table blocks. The contents of the E/O bit is used to select boundary grid points for the current input coordinates by determining whether the input falls between even and odd blocks or between odd and next even blocks. If the E/O bit=0, then the input coordinates fall between even and odd blocks. The read data from odd block becomes an upper value and the data from even block becomes a base value. If E/O bit=1, then, the input coordinates fall between odd and next even blocks. The read data from next even block becomes the upper value and the data from odd block becomes the base value. The delta value is derived by subtracting the bas value from the upper value.

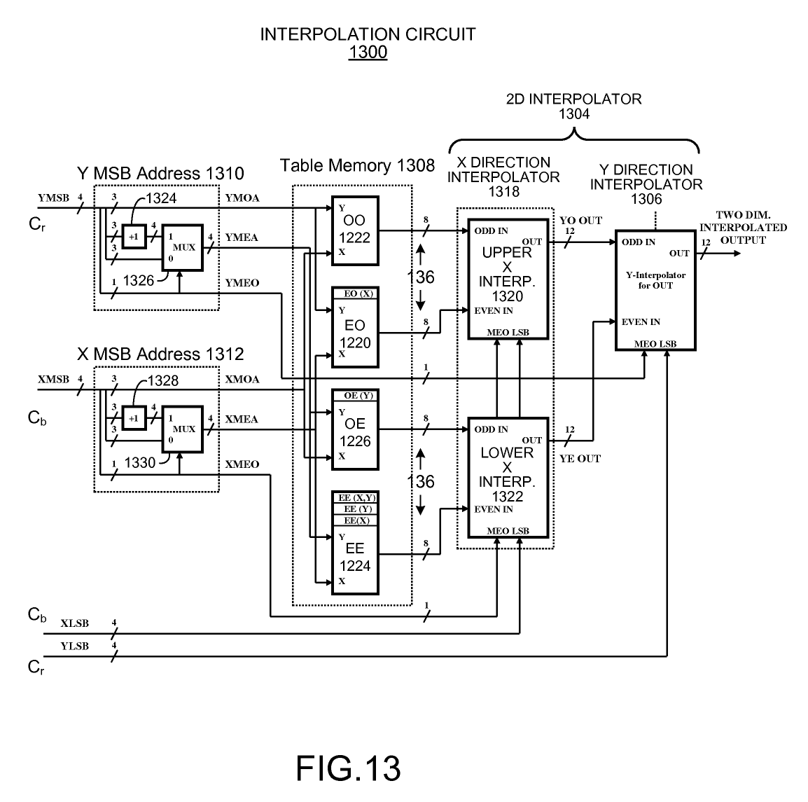

FIG. 13 a diagram showing a 2D interpolation circuit for implementing the 2D table remappers 802 shown in FIG. 8, each of which may be implemented in hardware and/or software. The 2D interpolation circuit 1300 includes, Y and X MSB address generators 1310 and 1312, a table memory 1308 for implementing the remap tables 804 coupled to the address generators 1310 and 1312, and a 2D interpolator 1304 coupled to the table memory 1308.

According to the exemplary embodiment, although the received differential color data 608 is 10 bits, the display data used to access the table memory module 1306 can be reduced to 4-bits because only 16+1 addresses are required in the table memory module 1306, where each address is capable of storing 8-bit color correction data 136. During operation of the display device 100, the interpolation circuit 1300 converts the 8-bit color correction data 136 into 12 bit data to produce more precise color correction, while interpolating data. Accordingly, the interpolation circuit 1300 is capable of receiving input differential color data 608 having a first bit length (e.g., 10 bits), uses only a subset of the differential color data 608 (e.g., 4-bit MSB 704) as an index to the table memory 1306 to reduce the size of the table memory 1308, and performs interpolation on the color correction data 136 retrieved from the table memory 1308 to produce remapped differential color data 608 having a larger bit length (e.g., 12-bits) than the input display data 130.

According to a further aspect of the exemplary embodiment, the table memory 1308 implements the remap tables 804 and is configured as four address memory blocks EO 1220, OO 1222, EE 1224, and OE 1226. Each of the memory blocks 1220, 1222, 1224, and 1226 are capable of 4-bit address input and may include 16 addresses, and 8-bit color correction data 136. In addition, each of the four memory blocks 1220, 1222, 1224, and 1226 includes even and or odd last additional addresses.

When the differential color data 608 address is received, a portion of the differential color data 608 (e.g., 4-bit MSB 704) is used to access the table memory 1308, and the four address memory blocks EO 1220, OO 1222, EE 1224, and OE 1226 are read in parallel to retrieve the four color correction data 136 values needed for 2D interpolation. According to this aspect of the exemplary embodiment, splitting the table memory 1308 into four increases the speed of the memory reads to keep better pace with the speed of the display data 130. In this embodiment, the color correction data 136 values can be read from the table memory 1308 at the same speed as the pixel clock for real time interpolation. Although in an alternative embodiment, the table memory 1308 could be implemented as a single memory, four serial memory reads would be required to obtain the color correction data 136 values stored at odd and even addresses, respectively, which would result in decreased performance. Otherwise, the table memory 1308 would need to be read at a rate four times faster than the pixel clock speed.

Performing parallel reads of the four address memory blocks EO 1220, OO 1222, EE 1224, and OE 1226 is achieved by first separating the differential display data 608 into the most significant bit (MSB) part 704 and the least significant (LSB) part 702 (FIG. 7). According to the exemplary embodiment, the MSB part 704 comprises most significant bits 9 through 6 of the differential color data 608 and is therefore 4-bits in length, and the LSB part 702 comprises bits 5 through 0 the differential color data 608 and is therefore 6-bits in length. Data from the 4-bit MSB parts 704 of Cᵣ (Y-direction) and C_{b} (X-direction) are used as memory addresses for table memory 1308 as follows.

The Y MSB address generator 1310 inputs the upper 3 bits of the Cᵣ MSB part 704 as a Y most significant odd address (YMOA) directly to the OO 1222 and EO 1220 of the table memory 1308. The 3-bit YMOA is also input to an adder 1324 and a multiplexer 1326 of the Y MSB address generator 1310. A Y most significant even/odd address (YMEO), the lower 1-bit of the MSB part 704, is used as input to the multiplexer 1326 and to the Y direction the interpolator 1306, which is part of the 2D interpolator 1304. The output of multiplexer 1326 is a 4-bit Y most significant even address (YMEA) used for accessing the OE 1226 and the EE 1224.

Similarly, X MSB address generator 1312 receives inputs the upper 3 bits of the C_{b} MSB part 704 as an X most significant odd address (XMOA) directly to the OO 1222 and OE 1226 of the table memory 1308. The 3-bit XMOA is also input to an adder and a multiplexer 1328 of the X MSB address generator 30. An X most significant even/odd address (XMEO), the lower 1-bit of the MSB part 704, is used as input to the multiplexer 1330 and to the lower X direction the interpolator 1306. The output of multiplexer 1330 is a 4-bit X most significant even address (XMEA) used for accessing the EO 1220 and the EE 1224.

Data addressing of the Y MSB address generator 1310 is performed as follows. The adder 1324 adds 1 to the YMOA, and outputs the resulting value as a 4-bit address. This 4-bit address is then input to the multiplexer 1326 along with the original YMOA and the YMEO. The multiplexer 1326 then checks the value of the YMEO to determine if the address in the YMOA is odd or even. If the value of the YMEO is one, then the address is odd and the multiplexer 1326 outputs the generated 4-bit address as the YMEA, which is used to read a color correction value from the table memory 1308. If the value of the YMEO is zero, then the address is even and the multiplexer uses the 3-bit YMOA to output the 4-bit YMEA, which is used to read a remapping value from the even MSB 1308. The generated 4-bit address is discarded in this case. Although only 3 bits are required to access the memory, an additional one bit value is added to access the table memory 1308 because when the last address (i.e., the maximum data address), of the YMOA is received, an additional even address is needed to perform the interpolation, so one bit is added by the adder 1324 to generate a 4-bit even address to access the OE 1226 and EE 1224. The addressing of the X MSB address generator 1312 is similar to the preceding description.

The table memory 1308 uses the Y most significant odd address (YMOA), the X most significant even address (XMOA), and the X most significant even/odd address (XMEA) to address the EO 1220, OO 1222 to fetch the two color correction data values for the upper X interpolation from blocks OO 1222 and EO 1220. Similarly, table memory 1308 uses the Y most significant even address (XMEA), the X most significant even address (XMOA), and the X most significant even address (XMEA) to address the EE 1224, and OE 1226 to fetch the two color correction data values for the lower X interpolation from blocks OE 1226 and EE 1224. As shown, the color correction data 136 output from the four address memory blocks EO 1220, OO 1222, EE 1224, and OE 1226 is 8 bits in length. The 8-bit color correction data 136 values are received by the x direction interpolator 1318.

The X direction interpolator 1318 comprises an upper X interpolator 1320 and a lower X interpolator 1322. The upper X interpolator 1320 performs upper X interpolation between the two input correction data values fetched from EO and OO addresses (See FIG. 10). The upper X interpolator 1320 outputs a Y odd interpolated value, YO out signal. The lower X-interpolator 1322 performs lower X-interpolation between the two correction values fetched from OE and EE addresses. The lower X interpolator 1322 outputs an Y even interpolated value, an YE out signal. The Y direction interpreter 1306 performs Y direction interpolation on the YO and YE out signals and outputs 2D interpolated output.

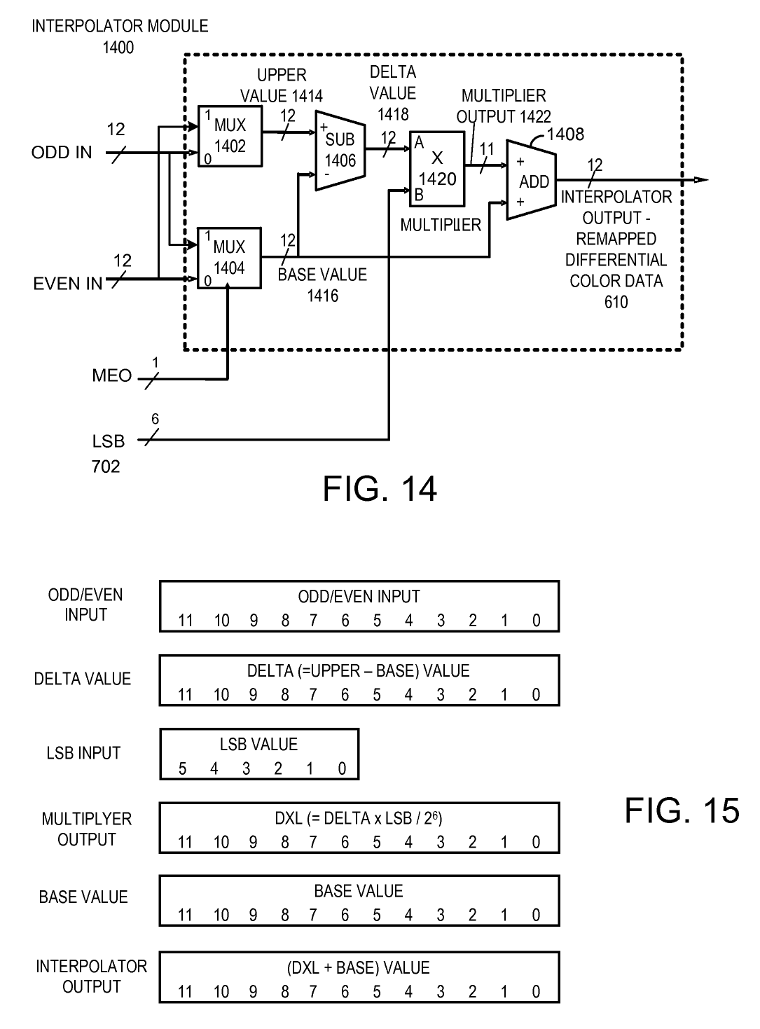

FIG. 14 is a diagram illustrating one embodiment an interpolator module for implementing the interpolators 1320, 1322 and 1306. According to the exemplary embodiment, each interpolator module 1400 comprises a multiplexer 1402, a multiplexer 1404, a data subtractor 1406, a multiplier 1420, and an adder 1408. The multiplexer 1402 receives color correction data 136 from odd addresses from the table memory module 1308, while the multiplexer 1404 receives color correction data 136 from even addresses. Both multiplexers 1402 and 1404 use the upper 8-bits of the 12-bit input, if the input is 8-bit and output 12-bit upper and base values 1414 and 1416, respectively, and interpolation is then performed between the upper and base values 1414 and 1416 with input from LSB part 702 of the input differential color data 608, as described below.

After the multiplexers 1402 and 1404 output the 12-bit upper and base values 1414 and 1416, interpolation between the upper and base values 1414 and 1416 is performed to generate the remapped differential color data 610. First, a delta value 1418 is generated by subtracting the base value 1416 from the upper value 1414 using subtracter 1404. Next, the LSB part 702 is multiplied with the delta value 1418 using multiplier 1420, generating multiplier output 1422. The multiplier output 1422 is then input to an adder 1408 with the base value 1416, the addition of which generates the interpolated remapped differential color data 610, Yₒᵤₜ, C_{b out}, and C_{r out} (12-bits each, 36-bits total).

FIG. 15 is a diagram illustrating bit arrangement of the interpolator module 1400 internal data bus bit alignment of variables used for generating the remapped differential color data 610 according to an exemplary embodiment.

According to further aspects of the exemplary embodiments, variations of the pixel grid 300 are provided. Due to the properties of hue, saturation, and intensity (HSI space), for proper remapping of color, the number of grid points needs to be increased in the central areas of the differential, space to provide more precise remapping. Accordingly, a further aspect of exemplary embodiment provides a multi-layer color space grid that increases the number of color correction data stored at the center of the color space grid to provide improved interpolation and increased precision of the color remapping.

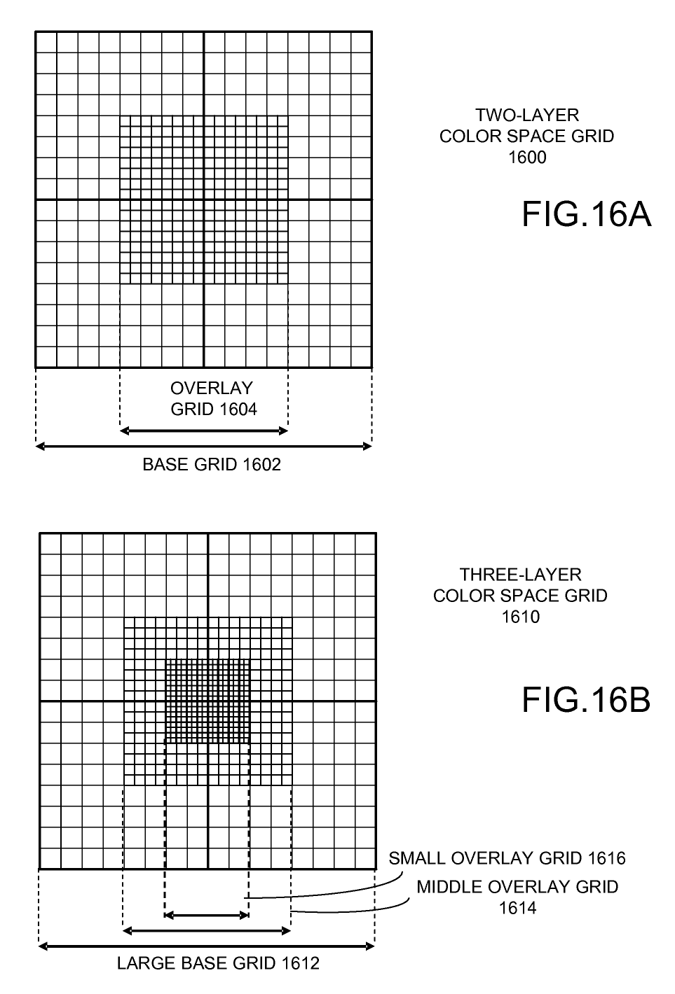

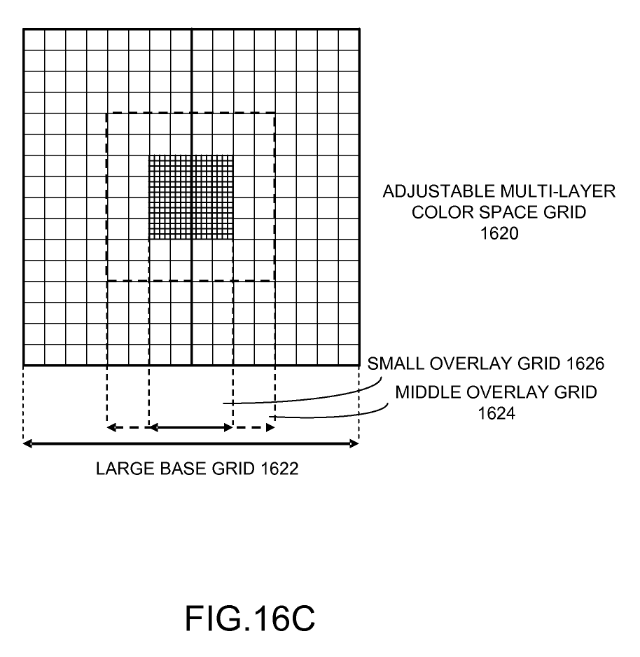

FIGS. 16A, 16B, and 16C are diagrams illustrating several embodiments for a multi-layered color space grid improved interpolation. FIG. 16A is a diagram illustrating a 2-dimensional two-layer color space grid for interpolation scheme in accordance with one embodiment of the present invention. As described above, the two-layer color space grid 1600 comprises a base grid 1602 that stores color correction data for a subset of C_{b} and Cᵣ (X and Y) coordinate values of the differential color space 210 at each grid point. The base grid 1602 is 17×17 in size and the X and Y coordinate values of the grid 1602 both range from 0-16. In this embodiment, however, a center area of X and Y coordinates in the base grid 1602 are provided with a greater number of grid points to increase precision of color remapping in the center area of the differential color space 210. This is accomplished by providing an overlay grid 1604 that is overlaid on a center area of the base grid 1602. In this embodiment, the overlay grid 1604 is 16×16 in size and is overlaid on the center 8×8 grid points of the base grid 1602.

FIG. 16B is a diagram illustrating an two-dimensional three-layer color space grid for interpolation scheme in accordance with another embodiment of the present invention. The three-layer color space grid 1610 includes a 17×17 large base grid 1612 and a 16×16 middle overlay grid 1614 that overlays the center 8×8 grid points of the large base grid 1612. In addition, the three layer color space grid 1610 further includes a small overlay grid 1616, which is also 16×16 in size, that is overlaid on a center area of the middle and large grids 1614 and 1612 to increase precision of the color remapping even further (in a 4×4 area of the large grid 1616 and a 8×8 area of the middle grid 1614). In this embodiment, the small overlay grid 1602 is overlaid with the 8×8 grid points in the center of middle overlay grid 1614, and the middle overlay grid 1614 is overlaid with the center 8×8 grid points of large base grid 1612.

FIG. 16C is diagram illustrating a two-dimensional multi-layer color space grid that has adjustable grid levels. In this example, an adjustable multi-layer color space grid 1620 is shown, where addressing can be switched between a large base grid 1622 and a middle overlay grid 1624, or between the large base grid 1622 and a small overlay grid 1626.

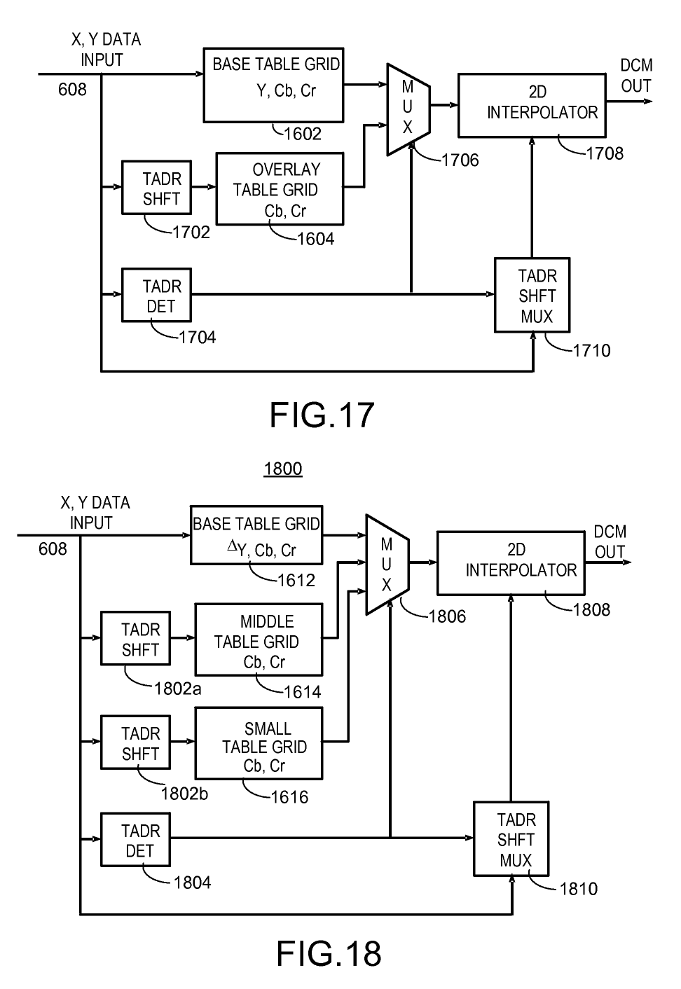

FIGS. 17, 18, and 19 are diagrams illustrating components of remapper units for implementing the multi-layer color space grid shown in FIGS. 16A-16C according to exemplary embodiments.

FIG. 17 is a block diagram of components of a remapper unit 1700 for implementing the two-layer color space grid 1600 of FIG. 16A. The remapper unit 1700 includes a base table for storing the base grid 1602, and an overlay table for storing the overlay grid 1604. The base grid 1602 stores Y, C_{b} and Cᵣ correction data. The overlay grid 1604 stores color correction data for C_{b} and Cᵣ, not Y because intensity is common and only the color components are remapped. The remapper unit 1700 includes a table address (TADR) shifter 1702, a table address (TADR) detector 1704, a multiplexer 1706 a 2D interpolator 1708, and a TADR shifter multiplexer 1710. The TADR shifter 1702 shifts the input differential color data 608 by one bit for higher density. TADR detector 1704 detector detects whether the input differential color data 608 address is inside the base grid 1602 or the overlay grid 1604 of the two-layer color space grid 1600 shown in FIG. 16A. The multiplexer 1706 is responsive to the output of the TADR detector 1704 and the color correction data received from the base grid 1602 and overlay grid 1604 for switching the input of the 2D interpolator 1708 to interpolate grid points inside or outside of the base grid 1602 and/or the overlay grid 1604. The TADR shifter multiplexer 1710 is responsive to output of the TADR detector 1704 for shifting between the LSB part 702 of the input address.

FIG. 18 is a block diagram of components of a remapper unit 1800 for implementing the three-layer color space grid 1610 of FIG. 16B. The remapper unit 1800 includes a base table for storing the base grid 1612, in middle table for stored in the overlay grid 1614, and a small table for storing the small overlay grid 1660. The base grid 1612 stores Y, C_{b} and Cᵣ correction data. The middle overlay grid 1604 and the small overlay grid 1616 store color correction data for C_{b} and Cᵣ. The remapper unit 1800 includes two TADR shifter 1802a and 1802b, a TADR detector 1804, a multiplexer 1806 a 2D interpolator 1808, and a TADR shifter multiplexer 1810. The two TADR shifters 1802a and 1802b shift the input differential color data 608 by one bit for higher density and inputs the result to the middle overlay grid 1614 and small overlay grid 1616, respectively. The TADR detector 1804 detector detects whether the input differential color data 608 address is inside the base grid 1602, the middle overlay grid 1614, or the small overlay grid 1616 of the two-layer color space grid 1610 shown in FIG. 16B. The multiplexer 1806 is responsive to the output of the TADR detector 1804 and the color correction data received from the base grid 1602, the middle overlay grid 1614, or the small overlay grid 1616 for switching the input of the 2D interpolator 1808 to interpolate grid points inside or outside of the base grid 1612, the middle overlay grid 1604, or the small overlay grid 1616. The TADR shifter multiplexer 1810 is responsive to output of the TADR detector 1804 for shifting between the LSB part 702 of the input address.

FIG. 20 is a diagram illustrating input data to base, middle, and small grid table address shift selection performed by the remapper 1800 of FIG. 18 in accordance with one embodiment of the present invention.

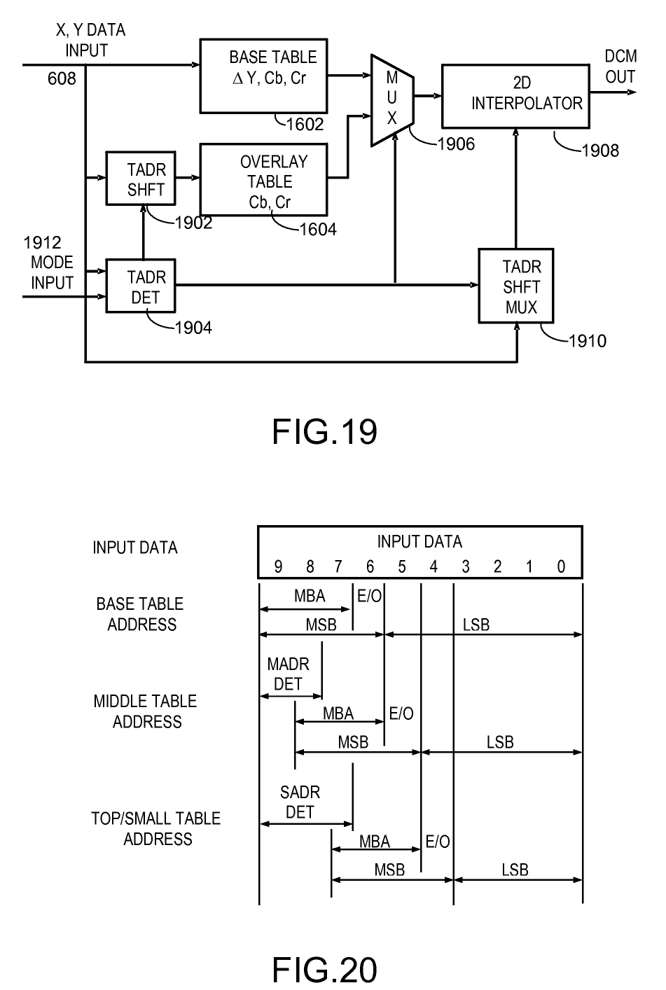

FIG. 19 is a block diagram of components of a remapper unit 1900 for implementing the adjustable multi-layer color space grid 1620 of FIG. 16C. The remapper unit 1900 is similar to the remapper unit 1700, but also includes a mode input 1912 signal for specifying mode switching between the base grid 1626 and a middle overlay grid 1624, or between the large base grid 1622 and a small overlay grid 1622. For a three layer grid, the mode input 1912 may include a small mode signal for switching interpolation to the small overlay grid 1626, a middle mode signal for switching interpolation to the middle overlay grid 1624, and a base mode signal for switching interpolation to the base grid 1622. Preferably, the mode control 1912 signal is controlled by the application program. In an exemplary embodiment, the base mode supports 10 bits, the middle mode supports 9 bits, and the small mode supports 8-bits.

A method and system for managing digital color for a display device has been disclosed. The present invention has been described in accordance with the embodiments shown, and one of ordinary skill in the art will readily recognize that there could be variations to the embodiments, and any variations would be within the spirit and scope of the present invention. For example, the embodiments are not restricted to the liquid crystal display, but also CRT and plasma displays are applicable. It is also possible to use any differential color space, including but not limited to YCᵣC_{b}, YUV, YIQ, YDᵣD_{b}, HSI, and HSV coordinates.

In addition, the embodiments can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

We claim:

1. A method of managing digital color for a display device having a display screen comprising:
receiving input display data comprising digital pixel data, wherein the data for each pixel represents 2D differential color space having X, Y coordinate values;
remapping at least a portion of the coordinate values of the input display data locally in coordinates of the differential color space by reading from a memory of the display device color correction data that is configured to correct color errors of the display screen, wherein the color correction data is also represented in the differential color space, but the color correction data is only stored for a subset of X, Y coordinate values comprising the differential color space;
interpolating the correction data read from the memory to generate remapped display data; and
outputting the remapped display data for subsequent display.

2. The method of claim 1 wherein the color correction data differential color coordinate values specify a displacement of input color space coordinates to new output color space coordinates, thereby remapping input colors to colors that are most near to correct colors.

3. The method of claim 1 further comprising representing the differential color space as YCC differential color space.

4. The method of claim 3 further comprising representing the differential color space as Y C_{b} Cᵣ differential color space, where C_{b} and Cᵣ are X and Y coordinates within the Y C_{b} Cᵣ differential color space, and Y is a 1-dimensional Z coordinate representing intensity.

5. The method of claim 1 wherein storing of the color correction data is performed during a configuration stage, comprising:
measuring color error of the display screen;
determining color correction data for correcting the color error;
dividing the differential color space into a color space grid of rows and columns, wherein points at row and column intersections of the color space grid are used to define shapes that encompass multiple differential color space coordinates; and
compressing the color correction data by storing in a memory of the display device the color correction data for points of the color space grid defining the shapes.

6. The method of claim 5 wherein in response to receiving differential color space coordinate values for a current pixel from the display data, reading the color correction data corresponding to the shape encompassing the differential color space coordinate values within the grid, and interpolating this color correction data to generate the remapped display data for the current pixel.

7. The method of claim 6 wherein the shapes of the color space grid defined by the points at the row and column intersections are blocks that are bounded by four grid points.

8. The method of claim 1 further comprising dividing the differential color space into a color space grid of N rows and M columns, wherein points at row and column intersections of the color space grid are used to define shapes that encompass multiple differential color space coordinates.

9. The method of claim 8 further comprising providing a 2-dimensional multi-layer color space grid that increases the number of color correction data stored at the center of the color space grid to provide improved interpolation and increased precision of the color remapping.

10. The method of claim 9 further comprising providing a two-layer color space grid comprising a base grid and an overlay grid that both store color correction data values at each grid point, wherein the overlay grid that is overlaid on a center area of the base grid to increase precision of color remapping in the center area of the differential color space.

11. The method of claim 10 wherein both the base grid is 17×17 in size, the overlay grid is 16×16 in size, and the overlay grid is overlaid on a center 8×8 grid points of the base grid.

12. The method of claim 9 further comprising providing a three-layer color space grid comprising a base grid, a middle overlay grid, and a small overlay grid, each storing color correction data values at each grid point, wherein the middle overlay grid is overlaid on a center area of the base grid and the small overlay grid is overlaid on center areas of the middle and large grids to increase precision of color remapping in a center area of the differential color space.

13. The method of claim 10 wherein the base grid is 17×17 in size, the middle overlay grid and the small overlay grid are each 16×16 in size, and the middle overlay grid is overlaid on a center 8×8 grid points of the base grid, and the small overlay grid is overlaid on a center 8×8 grid points of the middle overlay grid.

14. The method of claim 9 further comprising providing a multi-layer color space grid having adjustable grid levels.

15. The method of claim 1 further comprising in response to receiving the display data as RGB data, converting the RGB data into the differential color space, and after remapping the display data locally through interpolation of the color correction data in differential color space, outputting the remapped color data as RGB data.

16. A digital color management system for correcting color error of a display screen, comprising:
a 2-dimensional table memory for storing color correction data configured to correct color errors of the display screen, wherein the color correction data is represented in the differential color space having X, Y coordinate values, but the color correction data is only stored for a subset of X, Y coordinate values comprising the differential color space; and
a remapper unit coupled to the 2-dimensional table memory for receiving input display data comprising digital pixel data, wherein the data for each pixel represents 2-dimensional differential color space having X, Y coordinate values, and remapping at least a portion of the coordinate values of the input display data locally in coordinates of the differential color space by;
reading the color correction data values from the 2-dimensional table memory based in the input display data X, Y coordinate values,
interpolating the correction data read from 2-dimensional table memory to generate remapped display data, and
outputting the remapped display data for subsequent display.

17. The digital color management system of claim 16 further including a color space converter for receiving the input display as RGB data and converting the input display data from RGB into the differential color space and for outputting differential color data to the remapper unit.

18. The digital color management system of claim 17 wherein the color space converter receives 24-bit RGB display data and outputs the differential color data as 30-bit Y, C_{b}, and Cᵣ.

19. The digital color management system of claim 17 wherein the remapper receives the 30-bit Y, C_{b}, and Cᵣ differential color data and outputs 36-bit Y, C_{b}, and Cᵣ.

20. The digital color management system of claim 16 further including a reverse color space converter coupled to the remapper unit for converting the remapped color data back into RGB.

21. The digital color management system of claim 20 wherein the reverse color space converter receives the remapped color data as 36-bit Y, C_{b}, and Cᵣ and outputs 36-bit RGB remapped color data.

22. The digital color management system of claim 16 wherein the color correction data differential color coordinate values specify a displacement of input color space coordinates to new output color space coordinates, thereby remapping input colors to colors that are most near to the correct colors.

23. The digital color management system of claim 16 wherein the color correction data is stored in the 2-dimensional table memory during a configuration stage as a color space grid of rows and columns, wherein points at row and column intersections of the color space grid are used to define shapes that encompass multiple differential color space coordinates; and wherein the color correction data is compressed by storing the table memory the color correction data for points of the color space grid defining the shapes.

24. The digital color management system of claim 23 wherein in response to receiving differential color space coordinate values for a current pixel from the display data, the remapper unit reads the color correction data corresponding to the shape encompassing the differential color space coordinate values within the grid, and interpolates this color correction data to generate the remapped display data for the current pixel.

25. The digital color management system of claim 24 wherein the shapes of the color space grid defined by the points at the row and column intersections are blocks that are bounded by four grid points.

26. The digital color management system of claim 16 wherein the table memory divides the differential color space into a color space grid of N rows and M columns, wherein points at row and column intersections of the color space grid are used to define shapes that encompass multiple differential color space coordinates.

27. The digital color management system of claim 26 wherein the table memory stores is implemented as a 2-dimensional multi-layer color space grid that increases the number of color correction data stored at the center of the color space grid to provide improved interpolation and increased precision of the color remapping.

28. The digital color management system of claim 27 wherein the table memory stores is implemented as a two-layer color space grid comprising a base grid and an overlay grid that both store color correction data values at each grid point, wherein the overlay grid that is overlaid on a center area of the base grid to increase precision of color remapping in the center area of the differential color space.

29. The digital color management system of claim 28 wherein both the base grid is 17×17 in size, the overlay grid are 16×16 in size, and the overlay grid is overlaid on a center 8×8 grid points of the base grid.

30. The digital color management system of claim 27 wherein the table memory stores is implemented as a three-layer color space grid comprising a base grid, a middle overlay grid, and a small overlay grid, each storing color correction data values at each grid point, wherein the middle overlay grid is overlaid on a center area of the base grid and the small overlay grid is overlaid on center areas of the middle and large grids to increase precision of color remapping in a center area of the differential color space.

31. The digital color management system of claim 30 wherein the base grid is 17×17 in size, the middle overlay grid and the small overlay grid are each 16×16 in size, and the middle overlay grid is overlaid on a center 8×8 grid points of the base grid, and the small overlay grid is overlaid on a center 8×8 grid points of the middle overlay grid.

32. The digital color management system of claim 26 wherein the table memory stores is implemented as a multi-layer color space grid that has adjustable grid levels.

33. The digital color management system of claim 16 further comprising a gamma lookup table (GLUT) for performing gamma correction on the remapped display data using a 1D remap table containing intensity correction data to control the overall brightness of a displayed image.

34. The digital color management system of claim 33 further comprising a frame rate controller (FRC) for performing dynamic dither on the remapped display data and reducing bit width of the output remapped display data to match the data width of a display screen.

35. A digital color management system for correcting color error of a display device, comprising:
a memory for storing color correction data that is configured to correct color errors of the display screen, wherein the color correction data is represented in the differential color space and is only stored for a subset of X, Y coordinate values of the differential color space;
means responsive to receiving display data and for reading the color correction data from the memory based on the display data;
means for interpolating the color correction data read from the memory to generate remapped differential color data; and
means for outputting the remapped differential color data for subsequent display.

36. A method of managing digital color for a display device having a display screen, comprising:
measuring color error of the display screen;
determining color correction data for correcting the color error;
dividing the differential color space into a color space grid of rows and columns, wherein points at row and column intersections of the color space grid are used to define shapes that encompass multiple differential color space coordinates;
compressing the color correction data by storing in a memory of the display device the color correction data for points of the color space grid defining the shapes;
in response to receiving input display data comprising digital pixel data, wherein the data for each pixel represents 2D differential color space having X, Y coordinate values, reading from the memory the color correction data for the grid points of the block encompassing X, Y coordinate values of a current pixel;
interpolating the color correction data read from the memory to generate remapped color data for the current pixel position; and
outputting the remapped color data for subsequent display.
